(19) United States
(12) Patent Application Publication
(10) Pub. No.: US 2026/0370712 A1
(43) Pub. Date: Nov. 19, 2026

(54) CLOUD STORAGE PROCESSING METHOD AND DEVICE, STORAGE MEDIUM AND SYSTEM

(71) Applicant: CLOUD INTELLIGENCE ASSETS HOLDING (SINGAPORE) PRIVATE LIMITED, Singapore (SG)

(72) Inventor: Zhongqing CHEN, Hangzhou, Zhejiang (CN)

(21) Appl. No.: 19/477,337

(22) PCT Filed: May 22, 2024
(86) PCT No.: PCT/CN2024/094683

§ 371 Date: Oct. 21, 2025

(30) Foreign Application Priority Data
Jun. 1, 2023 (CN) 202310646348.7

(51) Int. Cl. H04L 67/1097; H04L 47/11

(52) U.S. Cl. CPC H04L 67/1097; H04L 47/115

(57) ABSTRACT

The present disclosure provides a cloud storage processing method and device, a storage medium and a system. The method includes: receiving, by a special-purpose processing chip, a data read/write request sent by a guest virtual machine, where the data read/write request includes a logical disk storage address corresponding to to-be-read/written data; sending a read/write request control signal including the logical disk storage address to a general-purpose processing chip, so that the general-purpose processing chip generates header information, where the header information includes identification information of a target storage server corresponding to the logical disk storage address; and receiving a packet sending control signal sent by the general-purpose processing chip and includes the header information, generating a network request packet according to the header information and the data read/write request, and sending the network request packet to the target storage server.

### CROSS-REFERENCE TO RELATED APPLICATIONS

This application is a National Stage of International Application No. PCT/CN2024/094683, filed on May 22, 2024, which claims priority to Chinese Patent Application No. 202310646348.7, filed with the China National Intellectual Property Administration on Jun. 1, 2023 and entitled “CLOUD STORAGE PROCESSING METHOD AND DEVICE, STORAGE MEDIUM AND SYSTEM”. The two applications are incorporated herein by reference in their entireties.

### TECHNICAL FIELD

The present disclosure relates to the technical field of cloud computing, and in particular, to a cloud storage processing method and device, a storage medium and a system.

### BACKGROUND

With continuous evolution of storage technologies, a storage medium has evolved from a conventional hard disk drive (HDD) to a solid state drive (SSD), and more recently, to an Optane SSD. The storage medium has a write latency reduced from milliseconds to microseconds, and throughput increased from MB/s to GB/s. At the same time, network bandwidths of data centers of cloud vendors also continuously increase.

Cloud storage systems such as cloud disks are relatively sensitive to a data read/write latency. A design goal is to provide a low-latency and high-throughput cloud storage system. Currently, the cloud storage systems mostly adopt an architecture in which computing is separated from storage, which generally includes a computing server cluster and a storage server cluster. The storage server cluster provides a physical storage space for data storage. One or more virtual machines may be deployed in each computing server and respectively correspond to different users, in which application programs of the corresponding users run. In addition, a cloud storage service runs on the computing server, and the virtual machine triggers a data read/write request to the storage server cluster by using the cloud storage service.

In a conventional cloud storage system, after generating a data read/write request, a guest virtual machine sends the data read/write request to a central processing unit (CPU) in a computing server. The CPU performs related data processing, and generates, based on a type of a network protocol between a storage server cluster and the computing server and by using some network transmission control policies, a network packet sent to a storage server, so as to send the network packet to the storage server by using a network interface card, so that the storage server completes a corresponding data read/write operation. A data processing process performed by the CPU generally needs to go through processes such as a virtualization software stack, a storage software stack, and a network protocol stack, involving numerous intermediate operations such as data copies and transformations (such as reading data from a memory or writing data into a memory, copying data to a network interface card, and performing security processing such as encryption and decryption on data), thereby resulting in a relatively long processing time.

Actually, the computing server may generally include a plurality of CPUs, and the data processing process and network transmission process above need to be completed by occupying several CPUs, which means that sufficient CPUs need to be reserved to complete these processing processes and the remaining CPUs can be used to construct the foregoing guest virtual machine, so CPU resources cannot be better utilized. In addition, it takes a relatively long time for the CPU to complete the data processing process and network transmission process above (e.g., the foregoing operations such as copying data to the memory and the network interface card, and encapsulating a network packet), resulting in a relatively long processing latency of a data read/write request and ultimately leading to poor throughput performance.

### SUMMARY

Embodiments of the present disclosure provide a cloud storage processing method and device, a storage medium and a system, to reduce a data read/write processing latency in cloud storage and improve throughput performance.

According to a first aspect, an embodiment of the present disclosure provides a cloud storage processing method, applied to a special-purpose processing chip that is in a computing server and is configured to provide a data plane function, where the method includes:
receiving a data read/write request sent by a guest virtual machine, where the data read/write request includes a logical disk storage address corresponding to to-be-read/written data;
sending a read/write request control signal including the logical disk storage address to a general-purpose processing chip that is in the computing server and is configured to provide a control plane function, so that the general-purpose processing chip generates header information, where the header information includes identification information of a target storage server corresponding to the logical disk storage address;
receiving a packet sending control signal sent by the general-purpose processing chip, where the packet sending control signal includes the header information; and
generating a network request packet according to the header information and the data read/write request, and sending the network request packet to the target storage server, so that the target storage server processes the data read/write request.

According to a second aspect, an embodiment of the present disclosure provides a cloud storage processing apparatus, applied to a special-purpose processing chip that is in a computing server and is configured to provide a data plane function, where the apparatus includes:
a receiving module, configured to receive a data read/write request sent by a guest virtual machine, where the data read/write request includes a logical disk storage address corresponding to to-be-read/written data;
a sending module, configured to send a read/write request control signal including the logical disk storage address to a general-purpose processing chip that is in the computing server and is configured to provide a control plane function, so that the general-purpose processing chip generates header information, where the header information includes identification information of a target storage server corresponding to the logical disk storage address;
the receiving module is further configured to receive a packet sending control signal sent by the general-purpose processing chip, where the packet sending control signal includes the header information; and a generation module, configured to generate a network request packet according to the header information and the data read/write request;

the sending module is further configured to send the network request packet to the target storage server, so that the target storage server processes the data read/write request.

According to a third aspect, an embodiment of the present disclosure provides a cloud storage processing method, applied to a general-purpose processing chip that is in a computing server and is configured to provide a control plane function, where the method includes:
receiving a read/write request control signal sent by a special-purpose processing chip that is in the computing server and is configured to provide a data plane function, where the read/write request control signal is sent by the special-purpose processing chip after receiving a data read/write request sent by a guest virtual machine, the data read/write request includes a logical disk storage address corresponding to to-be-read/written data, and the read/write request control signal includes the logical disk storage address;
generating header information, where the header information includes identification information of a target storage server corresponding to the logical disk storage address; and
sending a packet sending control signal including the header information to the special-purpose processing chip, so that the special-purpose processing chip generates a network request packet according to the header information and the data read/write request and sends the network request packet to the target storage server, to cause the target storage server to process the data read/write request.

According to a fourth aspect, an embodiment of the present disclosure provides a cloud storage processing apparatus, applied to a general-purpose processing chip that is in a computing server and is configured to provide a control plane function, where the apparatus includes:
a receiving module, configured to receive a read/write request control signal sent by a special-purpose processing chip that is in the computing server and is configured to provide a data plane function, where the read/write request control signal is sent by the special-purpose processing chip after receiving a data read/write request sent by a guest virtual machine, the data read/write request includes a logical disk storage address corresponding to to-be-read/written data, and the read/write request control signal includes the logical disk storage address;

a generation module, configured to generate header information, where the header information includes identification information of a target storage server corresponding to the logical disk storage address; and
a sending module, configured to send a packet sending control signal including the header information to the special-purpose processing chip, so that the special-purpose processing chip generates a network request packet according to the header information and the data read/write request and sends the network request packet to the target storage server, to cause the target storage server to process the data read/write request.

According to a fifth aspect, an embodiment of the present disclosure provides a computing server, including: a memory, a general-purpose processing chip, a special-purpose processing chip, and a communication interface, where the memory stores an executable code, and when the executable code is executed by the general-purpose processing chip and the special-purpose processing chip, the cloud storage processing method according to the first aspect or the third aspect is performed.

According to a sixth aspect, an embodiment of the present disclosure provides a non-transitory machine-readable storage medium. The non-transitory machine-readable storage medium stores an executable code. When the executable code is executed by a general-purpose processing chip and a special-purpose processing chip in a computing server, at least the cloud storage processing method according to the first aspect or the third aspect may be implemented.

According to a seventh aspect, an embodiment of the present disclosure provides a cloud storage system, including:
a computing server cluster and a storage server cluster, where any computing server in the computing server cluster includes a guest virtual machine, a special-purpose processing chip configured to provide a data plane function, and a general-purpose processing chip configured to provide a control plane function;
the special-purpose processing chip is configured to perform the cloud storage processing method according to the first aspect; and
the general-purpose processing chip is configured to perform the cloud storage processing method according to the third aspect.

In a cloud storage processing solution provided in the embodiments of the present disclosure, a distributed cloud storage system including a computing server cluster and a storage server cluster is provided. Any computing server in the computing server cluster includes a guest virtual machine using a cloud storage service, a special-purpose processing chip configured to provide a data plane function, and a general-purpose processing chip configured to provide a control plane function. The special-purpose processing chip is, for example, a data processing unit (DPU), and the general-purpose processing chip is, for example, a CPU. In summary, the control plane function is mainly a network transmission control function, including, for example, control logic of sending a data read/write request to a network of a storage server and check logic of a network response packet fed back by the storage server. The data plane function is mainly data processing logic, including, for example, data copying, encryption, and network packet encapsulation. The special-purpose processing chip is better at processing data with simple processing logic and is not good at processing complex network transmission protocols, while the general-purpose processing chip is opposite, so that with reference to advantages of the general-purpose processing chip and the special-purpose processing chip, both cooperate to complete a processing task of a data read/write request triggered by the guest virtual machine, thereby obtaining better performance. In addition, for the computing server, only a small quantity of general-purpose processing chips may be allocated to provide the foregoing control plane function, and more general-purpose processing chips may be used to construct more guest virtual machines, so resources of the general-purpose processing chips may be more fully used.

Specifically, after receiving the data read/write request sent by the guest virtual machine, the special-purpose processing chip parses the data read/write request, generates a read/write request control signal including the logical disk storage address corresponding to the to-be-read/written data, and sends the read/write request control signal to the general-purpose processing chip. The general-purpose processing chip generates header information based on a set network transmission policy, where the header information includes the identification information of the target storage server corresponding to the logical disk storage address, and sends a packet sending control signal including the header information to the special-purpose processing chip. The special-purpose processing chip encapsulates the data read/write request according to the header information to generate a network request packet, and sends the network request packet to the target storage server, so that the target storage server processes the data read/write request, that is, completes a corresponding data read/write operation.

As can be seen, a network interface card function is actually integrated on the special-purpose processing chip, and network packet encapsulation processing may be directly performed on the data read/write request based on the header information fed back by the general-purpose processing chip, thereby reducing a data conversion operation (for example, for a data write request, a network request packet is directly encapsulated after to-be-written data is directly copied from a memory, and the to-be-written data does not need to be copied to the network interface card, thereby reducing a data copying operation), reducing a processing latency of the data read/write request, and improving processing throughput.

### BRIEF DESCRIPTION OF DRAWINGS

To describe the technical solutions in the embodiments of the present disclosure more clearly, the following briefly introduces the accompanying drawings required for describing the embodiments. Apparently, the accompanying drawings in the following description are some embodiments of the present disclosure, and a person of ordinary skill in the art may still derive other drawings from these accompanying drawings without creative efforts.

FIG. 1 is a schematic diagram of a cloud storage processing system according to an embodiment of the present disclosure.

FIG. 2 is an interactive flow chart of a cloud storage processing method according to an embodiment of the present disclosure.

FIG. 3 is an interactive flow chart of a cloud storage processing method according to an embodiment of the present disclosure.

FIG. 4 is an interactive flow chart of a cloud storage processing method according to an embodiment of the present disclosure.

FIG. 5 is a schematic diagram of a composition structure of a data plane according to an embodiment of the present disclosure.

FIG. 6 is a schematic diagram of a composition structure of a control plane according to an embodiment of the present disclosure.

FIG. 7 is a schematic diagram of a control plane processing process in a network packet sending process according to an embodiment of the present disclosure.

FIG. 8 is a schematic diagram of a control plane processing process in a network packet receiving process according to an embodiment of the present disclosure.

FIG. 9 is a schematic structural diagram of a cloud storage processing apparatus according to an embodiment of the present disclosure.

FIG. 10 is a schematic structural diagram of a cloud storage processing apparatus according to an embodiment of the present disclosure.

FIG. 11 is a schematic structural diagram of a computing server according to this embodiment.

### DESCRIPTION OF EMBODIMENTS

To make objectives, technical solutions, and advantages of embodiments of the present disclosure clearer, the following clearly and completely describes the technical solutions in the embodiments of the present disclosure with reference to the accompanying drawings in the embodiments of the present disclosure. Apparently, the described embodiments are some of rather than all of the embodiments of the present disclosure. All other embodiments obtained by a person of ordinary skill in the art based on the embodiments of the present disclosure without creative efforts shall fall within the protection scope of the present disclosure. In addition, a sequence of steps in the following method embodiments is merely an example and is not strictly limited.

It should be noted that, user information (including, but not limited to, user equipment information, user personal information, and the like) and data (including, but not limited to, data for analysis, stored data, displayed data, and the like) as referred to in the embodiments of the present disclosure are both information and data that are authorized by a user or that are sufficiently authorized by all parties, and collection, use, and processing of related data need to comply with related laws and regulations and standards of related countries and regions, and a corresponding operation entry is provided for the user to select authorization or rejection.

First, some concepts as referred to in the embodiments of the present disclosure are explained and described.

DPU: it is a large category of special-purpose processors, is another important computing chip in a data center scenario after a CPU and a Graphics Processing Unit (GPU), and provides a computing engine for a high-bandwidth, low-latency, and data-intensive computing scenario.

Non-volatile memory express (NVMe): the NVMe specially designs a data access protocol for a high-performance device, and is simpler and more lightweight, which can greatly improve storage performance in combination with a multi-queue technology.

Virtio: the Virtio is an I/O paravirtualization solution, and provides a communication framework and a programming interface between a guest operating system (guest OS) and a hypervisor (a virtualization management program) virtualization device, with advantages of improving performance and reducing cross-platform compatibility problems. The Virtio is widely applied to cloud computing.

Direct memory access (DMA): it is a function provided by some computer bus architectures, and enables an attached device (such as a disk drive) to directly send data to or read data from a memory of a mainboard of a computer.

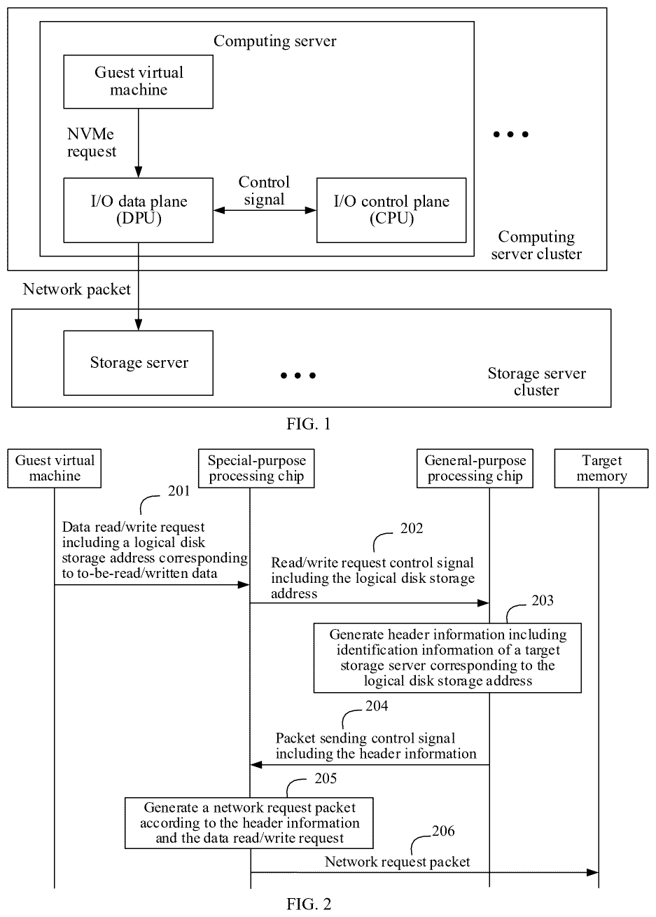

FIG. 1 is a schematic diagram of a cloud storage processing system according to an embodiment of the present disclosure. As shown in FIG. 1, the cloud storage processing system includes a computing server cluster and a storage server cluster.

The computing server cluster and the storage server cluster may be physically isolated. That is, the cloud storage processing system provided in this embodiment of the present disclosure may adopt an architecture in which storage is separated from computing.

The storage server cluster may include several storage servers, and physical storage media such as various types of disks are provided in each storage server. Only general-purpose processing chips may be deployed in these storage servers for performing local data access processing.

The computing server cluster may include several computing servers. Each computing server includes a guest virtual machine, a special-purpose processing chip configured to provide a data plane function (illustrated as an I/O data plane in FIG. 1), and a general-purpose processing chip configured to provide a control plane function (illustrated as an I/O control plane in FIG. 1). I/O represents input/output, and respectively corresponds to access processes of data writing and data reading of the guest virtual machine according to data transmission directions. Actually, a cloud storage service, for example, a common cloud disk service, also runs on the computing server. Each guest virtual machine invokes the cloud storage service to perform data read/write processing for the storage server cluster.

The guest virtual machines may be obtained by virtualizing hardware resources such as general-purpose processing chips in corresponding computing servers. At least one guest virtual machine may be constructed in one computing server, to be allocated to different users for use, and the users may run various application programs of the users in respective guest virtual machines. The guest virtual machine may generate a data read/write request in a process of running the application program, and may invoke the cloud storage service provided in the computing server to access the storage server cluster, to read/write to-be-read/written data.

The special-purpose processing chip includes, for example, the DPU shown in FIG. 1, and is not limited thereto. The special-purpose processing chip is configured to accelerate processing on the data read/write request triggered by the guest virtual machine. Therefore, some other special-purpose processing chips that can provide a computing acceleration function are applicable. The general-purpose processing chip includes, for example, the CPU shown in FIG. 1.

Actually, each computing server may include a plurality of general-purpose processing chips (for example, a plurality of CPUs, which generally refers to a plurality of CPU cores). These general-purpose processing chips are configured to construct one or more guest virtual machines on one hand, and are configured to provide the foregoing control plane function on the other hand.

Compared with a conventional solution in which the data read/write request is processed only by using the general-purpose processing chip, in this embodiment of the present disclosure, a processing process of the data read/write request is divided into two processing processes, namely, a data plane and a control plane. A control plane function mainly refers to a function of a network transport layer, and is used to perform network transmission control processing. A data plane function is mainly to perform data reception/transmission and related computing processing based on a network transmission control processing result. The control plane function is provided by the general-purpose processing chip, and the data plane function is provided by the special-purpose processing chip. The special-purpose processing chip (such as the DPU) is limited by programmability thereof and is not suitable for processing complex states and logic (such as processing complex network transmission protocols), but has better performance than the general-purpose processing chip (the CPU) for simple logic processing. However, the general-purpose processing chip is just opposite. When processing the data, the general-purpose processing chip needs to interact with related components such as a network interface card and a memory, resulting in a longer processing time. Based on this, in this embodiment of the present disclosure, only a small quantity of general-purpose processing chips need to be allocated to the computing server to provide the control plane function, and more general-purpose processing chips may be used to construct a guest virtual machine provided for a user to use, thereby improving utilization of the general-purpose processing chips.

In addition, based on an architecture in which the control plane is separated from the data plane, logic that is simple in logic but needs to process a large amount of data in a cloud storage system is separated to the data plane and is implemented in the special-purpose processing chip (such as the DPU), so that I/O processing performance can be improved, that is, processing performance of the data read/write request can be improved. I/O routing, congestion control, and retransmission mechanisms are all handled by the control plane, which can simplify the design of the data plane and implement a complete network transport layer function.

In addition, by using the foregoing architecture in which the control plane is separated from the data plane, the control plane function is irrelevant to data, which can provide better flexibility. For example, when a network protocol used between the computing server cluster and the storage server cluster needs to be updated, the general-purpose processing chip mainly needs to be adapted and updated, which is more cost-effective.

As shown in FIG. 1, based on the foregoing architecture in which the control plane is separated from the data plane, a guest virtual machine in a computing server may send, based on an interface specification corresponding to virtualization software, a data read/write request to a special-purpose processing chip providing a data plane function, for example, an NVMe request sent by using an NVMe specification shown in FIG. 1. A control signal is transmitted between the special-purpose processing chip and the general-purpose processing chip (the CPU), and does not carry data content to-be-read/written, reducing an overhead of the control plane. Based on a control plane processing result of the general-purpose processing chip, the special-purpose processing chip may transmit a network packet with a storage server.

Operating processes of a special-purpose processing chip and a general-purpose processing chip in a computing server are respectively described below with reference to the following embodiments.

FIG. 2 is an interactive flow chart of a cloud storage processing method according to an embodiment of the present disclosure. As shown in FIG. 2, the method includes the following steps.
201: a guest virtual machine sends a data read/write request to a special-purpose processing chip, where the data read/write request includes a logical disk storage address corresponding to to-be-read/written data.
202: the special-purpose processing chip sends a read/write request control signal including the logical disk storage address to a general-purpose processing chip.
203: the general-purpose processing chip generates header information, where the header information includes identification information of a target storage server corresponding to the logical disk storage address.
204: the general-purpose processing chip sends a packet sending control signal including the header information to the special-purpose processing chip.
205: the special-purpose processing chip generates a network request packet according to the header information and the data read/write request.
206: the special-purpose processing chip sends the network request packet to the target storage server, so that the target storage server processes the data read/write request.

An application program running on the guest virtual machine may generate a data read/write requirement, thereby triggering the foregoing data read/write request. The data read/write request is a general term for a data read request and a data write request.

During actual application, communication between the special-purpose processing chip and the guest virtual machine may conform to an interface specification, for example, Virtio or NVMe. Using the NVMe specification as an example, the guest virtual machine may encapsulate, according to the interface specification, a data read/write request triggered by the application program, to obtain an NVMe request, and sends the NVMe request to the special-purpose processing chip.

The data read/write request includes a logical disk storage address corresponding to to-be-read/written data, and the logical disk storage address is a logical block address (LBA). For a cloud storage service (generally referred to as a cloud disk service) provided by the cloud storage system, when using the cloud storage service, the user may allocate an LBA address range corresponding to a capacity (for example, 1 TB) thereto, and the guest virtual machine needs to carry the LBA when triggering a data read/write request. Specifically, if a current data read/write request is a data read request, the LBA indicates a logical storage address corresponding to the to-be-read data in the storage server cluster, and needed data needs to be read from the address. If the current data read/write request is a data write request, the LBA indicates that the to-be-written data needs to be written to the logical storage address in the storage server cluster.

Actually, the foregoing data read request may further include a memory address. For the data write request, the memory address indicates that the to-be-written data has been written to the memory address, and the special-purpose processing chip needs to copy the to-be-written data from the memory address, to finally transmit the to-be-written data to a storage server. For the data read request, the memory address indicates that data read from the storage server cluster needs to be written to the memory address by the special-purpose processing chip, to facilitate the guest virtual machine to acquire the data therefrom.

After receiving the foregoing NVMe request, the special-purpose processing chip parses the NVMe request, so as to extract the logical disk storage address therefrom, and may further extract the memory address, generate a read/write request control signal including the logical disk storage address (or further including the memory address), and send the read/write request control signal to the general-purpose processing chip.

The general-purpose processing chip generates, based on a locally configured network transmission policy, header information corresponding to the data read/write request. The header information includes identification information of a target storage server corresponding to the logical disk storage address, for example, an IP address and a port number of the target storage server.

The foregoing network transmission policy may include a pre-configured routing table. Corresponding routing information of different logical disk storage addresses of different guest virtual machines in the storage server cluster is recorded in the routing table. The routing information includes identification information of storage servers, and may further include corresponding physical storage addresses in the corresponding storage servers.

For example, assuming that the foregoing data read/write request triggered by a guest virtual machine A includes a logical disk storage address LBA═X, it is determined according to the foregoing routing table that the guest virtual machine A corresponds to a target storage server Z1, and the logical disk storage address LBA═X is mapped to a physical storage address Y, packet information generated by the general-purpose processing chip for the data read/write request includes identification information (an internet protocol (IP) address or the like) of the target storage server Z1and the physical storage address Y.

In addition, in an implementation, the foregoing network transmission policy may further include an I/O table. After receiving the foregoing read/write request control signal, the general-purpose processing chip may allocate read/write request identification information (which is referred to as an I/O identifier for ease of description) corresponding to the read/write request control signal. The I/O identifier is used for uniquely identifying a data read/write request. Since a control signal rather than original data is transmitted between the special-purpose processing chip and the general-purpose processing chip, that is, the foregoing data read/write request may not be transmitted between the two chips, to indicate that a control signal subsequently transmitted between the two chips is related to a same data read/write request, the I/O identifier is used as a representation.

After generating the foregoing I/O identifier, the general-purpose processing chip may store the I/O identifier in the I/O table. Actually, in an implementation, information stored in the I/O table together with the I/O identifier may further include a logical disk storage address, a memory address, and a receiving time (indicating when the data read/write request is triggered) that are extracted by the general-purpose processing chip from the received read/write request control signal. State information corresponding to the I/O identifier may further be recorded. The state information is used for indicating which processing state the data read/write request is in, including, for example, a receiving state, a state in which the data read/write request is sent to the storage server, a state in which a network response packet is received from the storage server, a state in which no network response packet is received within a time limit, and the like. When the foregoing I/O identifier is generated and stored in the I/O table, an initial state may be a receiving state, indicating that the data read/write request triggered by the guest virtual machine is received.

In addition, the general-purpose processing chip may further determine a network transmission parameter based on the network transmission control policy, for example, determine a data encryption parameter, a checksum parameter, and the like.

In conclusion, the header information generated by the general-purpose processing chip for the foregoing data read/write request based on the network transmission control policy includes, but is not limited to, the identification information of the target storage server, may further include an I/O identifier and another network transmission parameter, and may even further include an extracted memory address. The general-purpose processing chip organizes the generated header information into a packet sending control signal and sends the packet sending control signal to the special-purpose processing chip.

It should be noted that, in the process of sending the foregoing packet sending control signal to the special-purpose processing chip, the general-purpose processing chip may determine a congestion state of a network connection between the computing server and the target storage server, and determine a sending time of the packet sending control signal according to the congestion state, to send the packet sending control signal to the special-purpose processing chip according to the sending time. In short, if the foregoing network connection is currently in a non-congestion state, the packet sending control signal may be immediately sent to the special-purpose processing chip. Otherwise, whether the network connection is in the congestion state may be determined after a wait for a set duration. That is, the network transmission control policy of the general-purpose processing chip further includes network congestion control.

After receiving the foregoing packet sending control signal, the special-purpose processing chip encapsulates the network request packet according to the foregoing header information carried therein.

For example, if the data read/write request is a data write request, the data write request includes a memory address corresponding to to-be-written data, so that in an implementation, the read/write request control signal and the packet sending control signal may also include the memory address. In this case, the special-purpose processing chip may read the to-be-written data from the memory address based on the DMA, and generate the network request packet according to the header information and the to-be-written data. A header portion of the network request packet includes information such as the identification information of the target storage server and the I/O identifier. When the foregoing header information includes a data encryption parameter, the special-purpose processing chip further performs encryption processing on the to-be-written data based on the data encryption parameter, and a payload portion of the network request packet is filled with encryption results.

Then, the special-purpose processing chip sends the encapsulated network request packet to the target storage server, so that the target storage server performs corresponding data read/write processing.

In conclusion, based on the architecture in which the control plane is separated from the data plane, logic that is simple in processing logic but needs to process a large amount of data is separated to the data plane and is implemented in the special-purpose processing chip, and a complex network transmission control function is separated to the control plane and is implemented in the general-purpose processing chip. In one computing server, only a small quantity of general-purpose processing chips may be allocated to be responsible for processing the control plane function, and a small quantity of special-purpose processing chips are deployed to process the data plane function, resulting in a lower overall cost. Moreover, the special-purpose processing chip may accelerate processing on the data plane function (for example, due to integration with a network interface card function, the memory address only needs to be read or written once). This can reduce a processing time of the data read/write request and improve throughput performance.

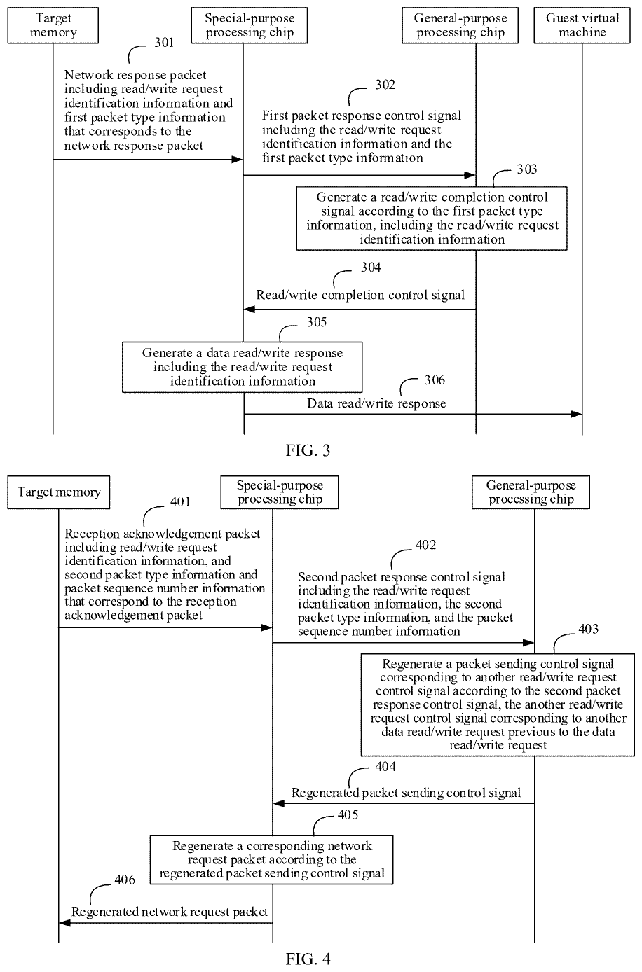

A process in which the special-purpose processing chip and the general-purpose processing chip send the data read/write request to the storage server cluster is described above. A process in which the network response packet fed back by the target storage server is processed is described below with reference to the embodiments shown in FIG. 3 and FIG. 4.

FIG. 3 is an interactive flow chart of a cloud storage processing method according to an embodiment of the present disclosure. As shown in FIG. 3, the method includes the following steps.
301: a target storage server sends a network response packet to a special-purpose processing chip, where the network response packet includes read/write request identification information and first packet type information that corresponds to the network response packet.
302: the special-purpose processing chip sends a first packet response control signal including the read/write request identification information and the first packet type information to a general-purpose processing chip.
303: the general-purpose processing chip generates a read/write completion control signal according to the first packet type information, including read/write request identification information.
304: the general-purpose processing chip sends the read/write completion control signal to the special-purpose processing chip.
305: the special-purpose processing chip generates a data read/write response including the read/write request identification information.
306: the special-purpose processing chip sends the data read/write response to a guest virtual machine.

After receiving the network request packet, the target storage server may perform corresponding data read/write processing, then generate a network response packet, and feed back the network response packet to the special-purpose processing chip.

It may be understood that, if the guest virtual machine triggers a data write request, the target storage server completes write processing on the to-be-written data. If the data read request is triggered, the target storage server completes read processing on the read data. In this case, the network response packet may carry the read data.

A header portion in the network response packet generated by the target storage server carries the I/O identifier and the first packet type information, and in addition, may further include, for example, identification information of the target storage server. The first packet type information is used for representing that a packet of a type such as a network response packet is sent. This type information indicates that the target storage server has successfully completed corresponding data read/write processing.

After receiving the network response packet, the special-purpose processing chip parses the network response packet, to extract the I/O identifier and the first packet type information therefrom, generates the first packet response control signal including the I/O identifier and the first packet type information, and sends the first packet response control signal to the general-purpose processing chip, to notify the general-purpose processing chip that the network response packet fed back by the target storage server has been received.

The general-purpose processing chip determines, based on the first packet type information, that the special-purpose processing chip has received the network response packet fed back by the target storage server. Therefore, the read/write completion control signal may be generated and sent to the special-purpose processing chip. Actually, the general-purpose processing chip may update information of the congestion state of the network connection between the computing server and the target storage server based on the received first packet response control signal.

After receiving the foregoing read/write completion control signal, the special-purpose processing chip performs data read/write response processing, generates a data read/write response including the I/O identifier, and sends the data read/write response to the guest virtual machine. If the guest virtual machine triggers a data read request, the data read/write response processing includes: storing read data into a memory address in response to the read/write completion control signal. The memory address is the memory address included in the data read/write request.

Specifically, assuming that an interface specification used between the special-purpose processing chip and the guest virtual machine is NVMe, the foregoing data read/write response generated by the special-purpose processing chip is an NVMe response. The data read request may further include the foregoing memory address, so that the guest virtual machine reads data from the memory address.

The foregoing embodiment shown in FIG. 3 describes a situation in which the target storage server finally sends the network response packet to the special-purpose processing chip after completing data read/write processing. Actually, before sending the network response packet, the target storage server may further send another type of network packet, i.e., a reception acknowledgement packet, used for indicating that the network request packet sent by the special-purpose processing chip has been received. Based on the reception acknowledgement packet, the general-purpose processing chip may perform network retransmission control. Refer to the embodiment shown in FIG. 4.

FIG. 4 is an interactive flow chart of a cloud storage processing method according to an embodiment of the present disclosure. As shown in FIG. 4, the method includes the following steps.
401. a target storage server sends a reception acknowledgement packet to a special-purpose processing chip, including read/write request identification information, and second packet type information and packet sequence number information that correspond to the reception acknowledgement packet.
402: the special-purpose processing chip sends a second packet response control signal including the read/write request identification information, the second packet type information, and the packet sequence number information to a general-purpose processing chip.
403: the general-purpose processing chip regenerates, according to the second packet response control signal, a packet sending control signal corresponding to another read/write request control signal, where the another read/write request control signal corresponds to another data read/write request previous to the data read/write request.
404: the general-purpose processing chip sends the regenerated packet sending control signal to the special-purpose processing chip.
405: the special-purpose processing chip regenerates a corresponding network request packet according to the regenerated packet sending control signal.
406: the special-purpose processing chip sends the regenerated network request packet to a corresponding storage server.

For ease of description, in this embodiment, it is assumed that a same guest virtual machine sequentially triggers a data read/write request 1, a data read/write request 2, and a data read/write request 3. For a sending procedure of each data read/write request, reference may be made to the processing process of the embodiment shown in FIG. 2. It is assumed that the general-purpose processing chip sequentially sends corresponding packet sending control signals to the special-purpose processing chip for the three data read/write requests. It is assumed that target storage servers corresponding to the three data read/write requests are the same.

The special-purpose processing chip generates three corresponding network request packets according to the three sequentially received packet sending control signals and sequentially sends the three corresponding network request packets to the target storage server. Whenever receiving a network request packet, the target storage server may generate a corresponding second packet response control signal and send the second packet response control signal to the special-purpose processing chip. The second packet response control signal may include a packet sequence number corresponding to the corresponding network request packet. The special-purpose processing chip compares ordering of packet sequence numbers in the sequentially received second packet response control signals, to determine whether some network request packets need to be retransmitted.

It is assumed that the data read/write request 1 corresponds to a network request packet 1, and a sending time is T1; the data read/write request 2 corresponds to a network request packet 2, and a sending time is T2; the data read/write request 3 corresponds to a network request packet 3, and a sending time is T3. For ease of description, it is assumed that a time required for the special-purpose processing chip to send the foregoing network request packet to the target storage server is ignored.

It is assumed that the target storage server currently receives the network request packet 3, thereby generating a reception acknowledgement packet 3 corresponding to the network request packet 3, including an I/O identifier carried in the network request packet 3, second packet type information indicating a type of a packet such as the reception acknowledgement packet, and packet sequence number information (which is a sequence number 3in this example) corresponding to the network request packet 3.

After receiving the second packet response control signal including the foregoing information, the general-purpose processing chip determines that the target storage server receives the network request packet 3, but the general-purpose processing chip finds, based on the received second packet response control signals, that the second packet response control signals corresponding to the network request packet 1 and the network request packet 2 have not been received, indicating that the network request packet 1 and the network request packet 2 have not been received by the target storage server, which indicates that the two network request packets are lost. In this case, the general-purpose processing chip triggers retransmission processing on the two network request packets: regenerating, based on the previously received read/write request control signals corresponding to the two corresponding data read/write requests, corresponding packet sending control signals, and sending the corresponding packet sending control signals to the special-purpose processing chip, so that the special-purpose processing chip regenerates the foregoing two network request packets according to the received packet sending control signals and sends the two network request packets to the target storage server.

In conclusion, in this embodiment of the present disclosure, the cloud storage system is disassembled into an architecture in which the control plane is separated from the data plane, the data plane is implemented in the special-purpose processing chip, and the control plane is implemented in the general-purpose processing chip. The special-purpose processing chip has a limited programming capability, and is not suitable for processing complex states and logic, but has better performance than the general-purpose processing chip (the CPU) for simple logic processing, which can improve I/O processing performance. The data-independent I/O and transport layer control plane provided can implement a complete network transport layer function with congestion control and reliable transmission capabilities. I/O routing, congestion control, and retransmission processing are handled by the control plane, which has high flexibility and reliability and simplifies the design of the data plane. Only control signals are transmitted between the data plane and the control plane, and no data is carried, thereby reducing an overhead of the control plane. Construction of the header information is completed by the control plane, enabling low-cost switching between different network transport layer protocols.

A process of cooperation between the general-purpose processing chip and the special-purpose processing chip is described above. A composition structure of a data plane function on the special-purpose processing chip and a composition structure of a control plane function on the general-purpose processing chip are respectively illustrated below.

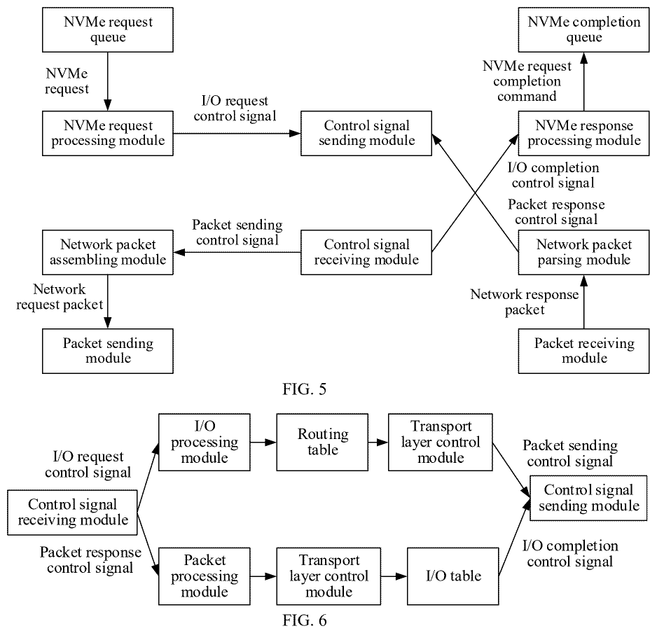

FIG. 5 is a schematic diagram of a composition structure of a data plane according to an embodiment of the present disclosure. As shown in FIG. 5, a guest virtual machine triggers a data read/write request, that is, an I/O request. Specifically, it is assumed that an I/O request (referred to as an NVMe request) triggered by using the NVMe specification may first enter an NVMe request queue, and an NVMe request processing module may consume the NVMe request queue, that is, sequentially read an NVMe request from the NVMe request queue, extract I/O information (such as an LBA and a memory address) therein, generate an I/O request control signal (that is, the foregoing read/write request control signal), and send the I/O request control signal to a control signal sending module, so that the control signal sending module sends the I/O request control signal to the control plane.

After receiving a packet sending control signal sent by the control plane, a control signal receiving module sends the packet sending control signal to a network packet assembling module. The network packet assembling module constructs a network packet header according to the packet sending control signal, acquires to-be-written data (it is assumed that the NVMe request is a data write request) by using the DMA, assembles the to-be-written data to generate a network request packet, and sends the network request packet to a packet sending module, so that the packet sending module sends the network request packet to the target storage server. After reaching the packet receiving module in the data plane, the network response packet of the target storage server is sent to a network packet parsing module. After determining that a received network packet conforms to a set characteristic (for example, first packet type information indicating that a packet type is a network response packet is received), the network packet parsing module generates a packet response control signal, and sends the packet response control signal to the control signal sending module, so that the control signal sending module sends the packet response control signal to the control plane. After receiving an I/O completion control signal (that is, the foregoing read/write completion control signal) sent by the control plane, the control signal receiving module sends the I/O completion control signal to an NVMe response processing module. The NVMe response processing module constructs an NVMe request completion command (that is, the foregoing data read/write response), and sends the NVMe request completion command to an NVMe request completion queue.

FIG. 6 is a schematic diagram of a composition structure of a control plane according to an embodiment of the present disclosure. As shown in FIG. 6, the control plane receives, from the control signal receiving module, various control signals from the data plane.

An I/O request control signal may enter an I/O processing module. The I/O processing module may check an I/O request, allocate a unique identifier of the I/O request, and write the unique identifier into an I/O table. Then, the I/O request may enter a routing table, and a target storage server corresponding to the I/O request is found. Finally, the I/O request enters a transport layer control module, congestion control is performed, and a packet sending control signal is generated, so as to be sent to the data plane by using the control signal sending module. The I/O request control signal includes an LBA and a memory address. The checking an I/O request includes, for example, determining, according to the two addresses, whether data volumes to be read/written are the same, and determining whether data volumes to be read/written exceed an upper capacity limit that can be used by a guest virtual machine. For example, if data of 500 MB needs to be written, address ranges described by the foregoing two addresses should be consistent with a data amount of 500 MB, and a storage space available to the guest virtual machine needs to be greater than a capacity of 500 MB.

A packet response control signal may enter a packet processing module. After parsing the packet response control signal, the packet processing module sends a packet response control signal to the transport layer control module. The transport layer control module determines a type of a network packet, and determines retransmission. Finally, the packet response control signal may enter the I/O table, corresponding I/O information is found according to the I/O identifier, and an I/O completion signal is generated, so as to be sent to the data plane by using the control signal sending module.

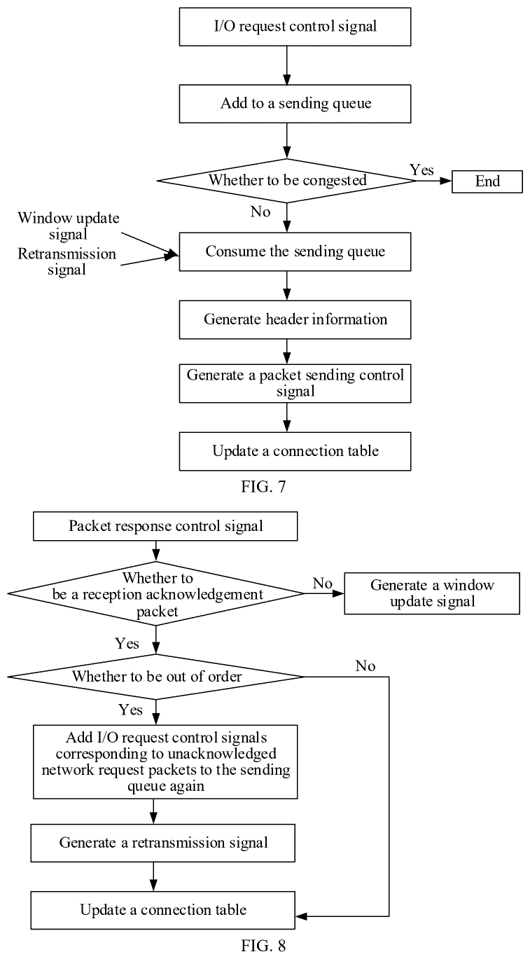

Processing processes of the transport layer control module in the control plane in a network packet sending and receiving process are respectively described below with reference to FIG. 7 and FIG. 8.

FIG. 7 is a schematic diagram of a control plane processing process in a network packet sending process according to an embodiment of the present disclosure. As shown in FIG. 7, an I/O request control signal, a retransmission signal, and a window update signal may all trigger a sending procedure of the transport layer control module.

Specifically, an I/O request control signal received from the data plane is first added to a sending queue, and then a congestion state of a network connection is checked. If the network connection is congested, the operation is directly ended (next determination is performed after a wait for a set duration). Otherwise, the transport layer control module may consume the sending queue, that is, take out an I/O request control signal therefrom, generate header information, generate a packet sending control signal, send the packet sending control signal to the data plane, and update a connection table.

The transport layer control module may maintain a connection table, in which congestion state information of network connections between different computing servers and storage servers may be recorded. For example, how many packet sending control signals (assumed to be N1 currently) have been sent and how many packet response control signals indicated as reception acknowledgement packets (assumed to be N2 currently) have been received on a network connection are recorded. Based on this, the foregoing congestion determination may be implemented as: determining whether a difference between N1 and N2 is greater than a set threshold, and if yes, it indicates that a network connection between a corresponding computing server and a storage server is in a congestion state; otherwise, the network connection is in a non-congestion state.

The updating a connection table may be simply understood as adding, after the packet sending control signal is sent, one to the value of N1 corresponding to a network connection between a corresponding computing server and a storage server.

FIG. 8 is a schematic diagram of a control plane processing process in a network packet receiving process according to an embodiment of the present disclosure. As shown in FIG. 8, after receiving a packet response control signal fed back by the data plane, the transport layer control module first determines whether it is a reception acknowledgement packet. Specifically, as described above, determination is performed according to packet type information carried in the packet response control signal. If not, it indicates that a network response packet is received, and a window update signal is generated. If yes, it is first checked whether the packet is out of order. The window update signal refers to generating a consumption signal to consume an I/O request control signal waiting in the sending queue.

If the packet is not out of order, the connection table is directly updated. The updating a connection table is, for example, adding one to the value of N2 corresponding to a network connection between a corresponding computing server and a storage server.

If the packet is out of order, I/O request control signals corresponding to unacknowledged network request packets are added to the sending queue shown in FIG. 7 again, to generate a retransmission signal, so as to retransmit these I/O request control signals, and finally the connection table is updated. For example, the value of N1 is updated according to a retransmission state, and the set threshold that is compared with the difference between N1 and N2 may also be adjusted.

A communication apparatus according to one or more embodiments of the present disclosure will be described below in detail. A person skilled in the art may understand that these apparatuses may be constructed by using commercially available hardware components and by using steps taught in this solution.

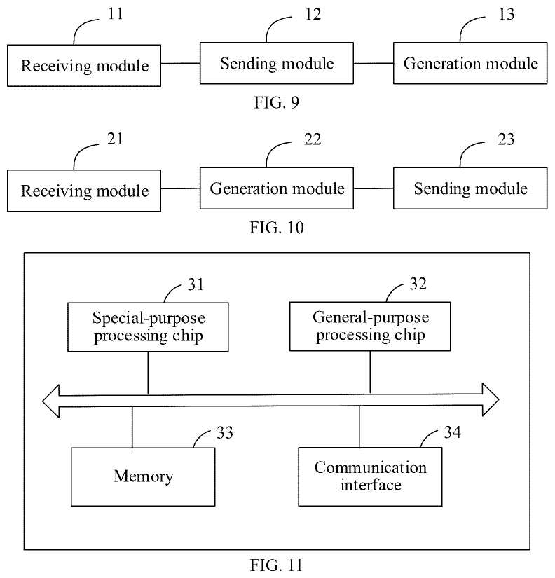

FIG. 9 is a schematic structural diagram of a cloud storage processing apparatus according to an embodiment of the present disclosure. The apparatus is applied to the foregoing special-purpose processing chip. As shown in FIG. 9, the apparatus includes: a receiving module 11, a sending module 12, and a generation module 13.

The receiving module 11 is configured to receive a data read/write request sent by a guest virtual machine. The data read/write request includes a logical disk storage address corresponding to to-be-read/written data.

The sending module 12 is configured to send a read/write request control signal including the logical disk storage address to a general-purpose processing chip that is in the computing server and is configured to provide a control plane function, so that the general-purpose processing chip generates header information. The header information includes identification information of a target storage server corresponding to the logical disk storage address.

The receiving module 11 is further configured to receive a packet sending control signal sent by the general-purpose processing chip. The packet sending control signal includes the header information.

The generation module 13 is configured to generate a network request packet according to the header information and the data read/write request.

The sending module 12 is further configured to send the network request packet to the target storage server, so that the target storage server processes the data read/write request.

The apparatus shown in FIG. 9 may perform steps performed by the special-purpose processing chip in the foregoing embodiments. For detailed execution processes and technical effects, refer to descriptions in the foregoing embodiments, and details are not described herein again.

FIG. 10 is a schematic structural diagram of a cloud storage processing apparatus according to an embodiment of the present disclosure. The apparatus is applied to the foregoing general-purpose processing chip. As shown in FIG. 10, the apparatus includes: a receiving module 21, a sending module 22, and a generation module 23.

The receiving module 21 is configured to receive a read/write request control signal sent by a special-purpose processing chip that is in the computing server and is configured to provide a data plane function. The read/write request control signal is sent by the special-purpose processing chip after receiving a data read/write request sent by a guest virtual machine. The data read/write request includes a logical disk storage address corresponding to to-be-read/written data. The read/write request control signal includes the logical disk storage address.

The generation module 22 is configured to generate header information. The header information includes identification information of a target storage server corresponding to the logical disk storage address.

The sending module 23 is configured to send a packet sending control signal including the header information to the special-purpose processing chip, so that the special-purpose processing chip generates a network request packet according to the header information and the data read/write request and sends the network request packet to the target storage server, to cause the target storage server to process the data read/write request.

The apparatus shown in FIG. 10 may perform steps performed by the general-purpose processing chip in the foregoing embodiments. For detailed execution processes and technical effects, refer to descriptions in the foregoing embodiments, and details are not described herein again.

An embodiment of the present disclosure further provides a computing server. As shown in FIG. 11, the computing server may include: a special-purpose processing chip 31, a general-purpose processing chip 32, a memory 33, and a communication interface 34. The memory 33 stores executable code. When the executable code is executed by the special-purpose processing chip 31 and the general-purpose processing chip 32, the cloud storage processing method in the foregoing embodiments is implemented.

In addition, an embodiment of the present disclosure provides a non-transitory machine-readable storage medium. The non-transitory machine-readable storage medium stores an executable code. When the executable code is executed by a general-purpose processing chip and a special-purpose processing chip in a computing server, the cloud storage processing method as provided in the foregoing embodiments may be implemented.

The described apparatus embodiments are merely exemplary, and the units described as separate parts may or may not be physically separate. Some or all of the modules may be selected according to actual requirements to achieve the objective of the solution of this embodiment. A person of ordinary skill in the art may understand and implement the embodiments of the present disclosure without creative efforts.

Through the descriptions of the foregoing implementations, a person skilled in the art may clearly understand that the implementations may be implemented by adding a necessary universal hardware platform, or certainly by combining hardware and software. Based on such an understanding, the foregoing technical solutions essentially or the part contributing to the prior art may be implemented in a form of a computer product. The present disclosure may use a form of a computer program product implemented on one or more computer-usable storage media (including, but not limited to, a disk memory, a compact disc read-only memory (CD-ROM), an optical memory, and the like) that include computer-usable program code.

Finally, it should be noted that, the foregoing embodiments are merely used for describing the technical solutions of the present disclosure, but are not intended to limit the technical solutions of the present disclosure. Although the present disclosure is described in detail with reference to the foregoing embodiments, a person of ordinary skill in the art should understand that they may still make modifications to the technical solutions described in the foregoing embodiments, or make equivalent replacements to some technical features thereof. These modifications or replacements do not cause the essence of the corresponding technical solutions to depart from the spirit and scope of the technical solutions of the embodiments of the present disclosure.

1. A cloud storage processing method, applied to a special-purpose processing chip that is in a computing server and is configured to provide a data plane function, wherein the method comprises:
receiving a data read/write request sent by a guest virtual machine, wherein the data read/write request comprises a logical disk storage address corresponding to to-be-read/written data;
sending a read/write request control signal comprising the logical disk storage address to a general-purpose processing chip that is in the computing server and is configured to provide a control plane function, so that the general-purpose processing chip generates header information, wherein the header information comprises identification information of a target storage server corresponding to the logical disk storage address;
receiving a packet sending control signal sent by the general-purpose processing chip, wherein the packet sending control signal comprises the header information; and
generating a network request packet according to the header information and the data read/write request, and sending the network request packet to the target storage server, so that the target storage server processes the data read/write request.

2. The method according to claim 1, wherein the packet sending control signal further comprises read/write request identification information that is allocated by the general-purpose processing chip and corresponds to the read/write request control signal; and the network request packet comprises the read/write request identification information.

3. The method according to claim 1, wherein the data read/write request is a data write request, the data write request comprises a memory address corresponding to to-be-written data; and
the generating the network request packet according to the header information and the data read/write request comprises:
reading the to-be-written data from the memory address; and
generating the network request packet according to the header information and the to-be-written data.

4. The method according to claim 2, wherein the method further comprises:
receiving a network response packet sent by the target storage server, wherein the network response packet comprises the read/write request identification information and first packet type information that corresponds to the network response packet;
sending a first packet response control signal comprising the read/write request identification information and the first packet type information to the general-purpose processing chip;
receiving a read/write completion control signal generated by the general-purpose processing chip according to the first packet type information, wherein the read/write completion control signal comprises the read/write request identification information; and
generating a data read/write response comprising the read/write request identification information, and sending the data read/write response to the guest virtual machine.

5. The method according to claim 4, wherein the data read/write request is a data read request, the data read request comprising a memory address corresponding to read data; and
the network response packet comprises the read data; and
the method further comprises:
storing the read data into the memory address in response to the read/write completion control signal.

6. The method according to claim 2, wherein the method further comprises:
receiving a reception acknowledgement packet sent by the target storage server, wherein the reception acknowledgement packet comprises the read/write request identification information, and second packet type information and packet sequence number information that correspond to the reception acknowledgement packet; and the reception acknowledgement packet is used for indicating reception of the network request packet;
sending a second packet response control signal comprising the read/write request identification information, the second packet type information, and the packet sequence number information to the general-purpose processing chip;
receiving a packet sending control signal that is regenerated by the general-purpose processing chip according to the second packet response control signal and corresponds to another read/write request control signal; wherein the another read/write request control signal corresponds to another data read/write request previous to the data read/write request; and
regenerating a corresponding network request packet according to the regenerated packet sending control signal, and sending the corresponding network request packet to a corresponding storage server.

7. A cloud storage processing method, applied to a general-purpose processing chip that is in a computing server and is configured to provide a control plane function, wherein the method comprises:
receiving a read/write request control signal sent by a special-purpose processing chip that is in the computing server and is configured to provide a data plane function, wherein the read/write request control signal is sent by the special-purpose processing chip after receiving a data read/write request sent by a guest virtual machine, the data read/write request comprises a logical disk storage address corresponding to to-be-read/written data, and the read/write request control signal comprises the logical disk storage address;
generating header information, wherein the header information comprises identification information of a target storage server corresponding to the logical disk storage address; and
sending a packet sending control signal comprising the header information to the special-purpose processing chip, so that the special-purpose processing chip generates a network request packet according to the header information and the data read/write request and sends the network request packet to the target storage server, to cause the target storage server to process the data read/write request.

8. The method according to claim 7, wherein the method further comprises:
allocating read/write request identification information corresponding to the read/write request control signal; wherein the packet sending control signal and the network request packet comprise the read/write request identification information.

9. The method according to claim 7, wherein the sending the packet sending control signal comprising the header information to the special-purpose processing chip comprises:
determining a congestion state of a network connection between the computing server and the target storage server;
determining a sending time of the packet sending control signal according to the congestion state; and
sending the packet sending control signal to the special-purpose processing chip according to the sending time.

10. The method according to claim 8, wherein the method further comprises:
receiving a first packet response control signal sent by the special-purpose processing chip, wherein the first packet response control signal comprises the read/write request identification information and first packet type information corresponding to a network response packet, the first packet response control signal is sent by the special-purpose processing chip after receiving the network response packet that is sent by the target storage server and corresponds to the network request packet, and the network response packet comprises the read/write request identification information and the first packet type information;
generating a read/write completion control signal according to the first packet type information, wherein the read/write completion control signal comprises the read/write request identification information; and
sending the read/write completion control signal to the special-purpose processing chip so that the special-purpose processing chip generates a data read/write response comprising the read/write request identification information and sends the data read/write response to the guest virtual machine.

11. The method according to claim 8, wherein the method further comprises:
receiving a second packet response control signal sent by the special-purpose processing chip, wherein the second packet response control signal comprises the read/write request identification information, and second packet type information and packet sequence number information that correspond to a reception acknowledgement packet, the second packet response control signal is sent by the special-purpose processing chip after receiving the reception acknowledgement packet that is sent by the target storage server and corresponds to the network request packet, and the reception acknowledgement packet comprises the read/write request identification information, the second packet type information, and the packet sequence number information; the reception acknowledgement packet is used for indicating reception of the network request packet; and
in a case that it is determined, according to the second packet type information and the packet sequence number information, that the network request packet is out of order, regenerating a packet sending control signal corresponding to another read/write request control signal, and sending the regenerated packet sending control signal to the special-purpose processing chip, so that the special-purpose processing chip regenerates a corresponding network request packet; wherein the another read/write request control signal corresponds to another data read/write request previous to the data read/write request.

12. A computing server, comprising: a memory, a general-purpose processing chip that is in a computing server and is configured to provide a control plane function, a special-purpose processing chip that is in the computing server and is configured to provide a data plane function, and a communication interface; wherein the memory stores an executable code, and the special-purpose processing chip, when executing the executable code, is configured to:
receive a data read/write request sent by a guest virtual machine, wherein the data read/write request comprises a logical disk storage address corresponding to to-be-read/written data;
send a read/write request control signal comprising the logical disk storage address to the general-purpose processing chip, so that the general-purpose processing chip generates header information, wherein the header information comprises identification information of a target storage server corresponding to the logical disk storage address;
receive a packet sending control signal sent by the general-purpose processing chip, wherein the packet sending control signal comprises the header information; and
generate a network request packet according to the header information and the data read/write request, and send the network request packet to the target storage server, so that the target storage server processes the data read/write request.

13. A non-transitory machine-readable storage medium, wherein the non-transitory machine-readable storage medium stores an executable code, and when the executable code is executed by special-purpose processing chip in a computing server, the cloud storage processing method according to claim 1 is performed.

14. A cloud storage system, comprising:
a computing server cluster and a storage server cluster, where any computing server in the computing server cluster includes a guest virtual machine, a special-purpose processing chip configured to provide a data plane function, and a general-purpose processing chip configured to provide a control plane function;
the special-purpose processing chip is configured to;
receive a data read/write request sent by the guest virtual machine, wherein the data read/write request comprises a logical disk storage address corresponding to to-be-read/written data;
send a read/write request control signal comprising the logical disk storage address to the general-purpose processing chip, so that the general-purpose processing chip generates header information, wherein the header information comprises identification information of a target storage server corresponding to the logical disk storage address;
receive a packet sending control signal sent by the general-purpose processing chip, wherein the packet sending control signal comprises the header information; and
generate a network request packet according to the header information and the data read/write request, and send the network request packet to the target storage server, so that the target storage server processes the data read/write request; and
the general-purpose processing chip is configured to perform the cloud storage processing method according to claim 7.

15. The computing server according to claim 12, wherein the packet sending control signal further comprises read/write request identification information that is allocated by the general-purpose processing chip and corresponds to the read/write request control signal; and the network request packet comprises the read/write request identification information.

16. The computing server according to claim 15, wherein the special-purpose processing chip is further configured to:
receive a network response packet sent by the target storage server, wherein the network response packet comprises the read/write request identification information and first packet type information that corresponds to the network response packet;
send a first packet response control signal comprising the read/write request identification information and the first packet type information to the general-purpose processing chip;
receive a read/write completion control signal generated by the general-purpose processing chip according to the first packet type information, wherein the read/write completion control signal comprises the read/write request identification information; and
generate a data read/write response comprising the read/write request identification information, and sending the data read/write response to the guest virtual machine; or
the special-purpose processing chip is further configured to:
receive a reception acknowledgement packet sent by the target storage server, wherein the reception acknowledgement packet comprises the read/write request identification information, and second packet type information and packet sequence number information that correspond to the reception acknowledgement packet; and the reception acknowledgement packet is used for indicating reception of the network request packet;
send a second packet response control signal comprising the read/write request identification information, the second packet type information, and the packet sequence number information to the general-purpose processing chip;
receive a packet sending control signal that is regenerated by the general-purpose processing chip according to the second packet response control signal and corresponds to another read/write request control signal; wherein the another read/write request control signal corresponds to another data read/write request previous to the data read/write request; and
regenerate a corresponding network request packet according to the regenerated packet sending control signal, and sending the corresponding network request packet to a corresponding storage server.

17. A computing server, comprising: a memory, a general-purpose processing chip that is in a computing server and is configured to provide a control plane function, a special-purpose processing chip that is in the computing server and is configured to provide a data plane function, and a communication interface; wherein the memory stores an executable code, and when the executable code is executed by the general-purpose processing chip, the cloud storage processing method according to claim 7 is performed.

18. The computing server according to claim 17, wherein the general-purpose processing chip is further configured to:
allocate read/write request identification information corresponding to the read/write request control signal; wherein the packet sending control signal and the network request packet comprise the read/write request identification information.

19. The computing server according to claim 18, wherein the general-purpose processing chip is further configured to:
receive a first packet response control signal sent by the special-purpose processing chip, wherein the first packet response control signal comprises the read/write request identification information and first packet type information corresponding to a network response packet, the first packet response control signal is sent by the special-purpose processing chip after receiving the network response packet that is sent by the target storage server and corresponds to the network request packet, and the network response packet comprises the read/write request identification information and the first packet type information;
generate a read/write completion control signal according to the first packet type information, wherein the read/write completion control signal comprises the read/write request identification information; and
send the read/write completion control signal to the special-purpose processing chip so that the special-purpose processing chip generates a data read/write response comprising the read/write request identification information and sends the data read/write response to the guest virtual machine; or
the general-purpose processing chip is further configured to:
receive a second packet response control signal sent by the special-purpose processing chip, wherein the second packet response control signal comprises the read/write request identification information, and second packet type information and packet sequence number information that correspond to a reception acknowledgement packet, the second packet response control signal is sent by the special-purpose processing chip after receiving the reception acknowledgement packet that is sent by the target storage server and corresponds to the network request packet, and the reception acknowledgement packet comprises the read/write request identification information, the second packet type information, and the packet sequence number information; the reception acknowledgement packet is used for indicating reception of the network request packet; and
in a case that it is determined, according to the second packet type information and the packet sequence number information, that the network request packet is out of order, regenerate a packet sending control signal corresponding to another read/write request control signal, and send the regenerated packet sending control signal to the special-purpose processing chip, so that the special-purpose processing chip regenerates a corresponding network request packet; wherein the another read/write request control signal corresponds to another data read/write request previous to the data read/write request.

20. A non-transitory machine-readable storage medium, wherein the non-transitory machine-readable storage medium stores an executable code, and when the executable code is executed by a special-purpose processing chip in a computing server, the cloud storage processing method according to claim 7 is performed.
